(19) United States
(12) Patent Application Publication
(10) Pub. No.: US 2005/0193130 A1
(43) Pub. Date: Sep. 1, 2005

(54) Methods and systems for confirmation of availability of messaging account to user

(75) Inventors: Jay D. Logue, San Jose, CA (US); Timothy T. Sullivan, Portola Valley, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: MBLX LLC

(21) Appl. No.: 11/039,416

(22) Filed: Jan. 20, 2005

Related U.S. Application Data
(60) Provisional application No. 60/538,313, filed on Jan. 22, 2004.

(51) Int. Cl. G06F 15/16

(52) U.S. Cl. 709/229; 709/206

(57) ABSTRACT

Systems and methods are provided for verifying that a user owns a remote account. When a user specifies from a local account a remote account to which the user desires access, an authentication server connected to the local account sends a verification message to the remote account, addressed to the remote address specified by the user. The verification message contains a marker which is irreproducible by a third party. The verification message is returned or retrieved and the marker is analyzed to determine whether it is authentic. The receipt of the marker may also have to satisfy certain use-based requirements. If the marker is validated, the user is allowed to access the remote account.

### CROSS-REFERENCE TO RELATED APPLICATIONS

This application claims priority to and the benefit of U.S. Provisional Patent Application Ser. No. 60/538,313, filed Jan. 22, 2004 and entitled METHODS AND SYSTEMS FOR CONFIRMATION OF AVAILABILITY OF MESSAGING ACCOUNT TO USER, which is hereby incorporated by reference herein in its entirety.

### BACKGROUND OF THE INVENTION

1. The Field of the Invention

The present invention relates generally to managing electronic messages. Specifically, the present invention relates to authenticating whether a remote address is valid for a corresponding remote account.

2. The Relevant Technology

Current messaging programs allow users to access a remote account from a local account. This allows a user to access electronic messaging functions from the remote account. Some messaging systems allow the user to control the functions of the remote account at the local account. Thus, the user may be able to control messaging functions of one or more accounts at one location. Still other messaging systems import mail from the remote account to the local account without necessarily giving the user ability to control the remote account. An example is forwarding messages in the inbox of the remote account to the inbox of the local account.

In the context of email, when setting up a connection to a remote account, the email client program on the local server often requires the user to identify certain things which authorize access to the remote account. These include an incoming mail (such as POP3) server, an outgoing mail (such as SMTP) server, and a remote messaging address. The client program may also require a signon name and password to allow the local server access to the remote account.

Providing the client program with server identification, signon and password for the remote account allows the local account access thereto. Thus, email client servers do not verify that the remote messaging address is actually the messaging address that corresponds to the remote account because it is unnecessary in order to provide access to the remote account. This allows a user to sometimes select a remote messaging address that is different than the address that actually corresponds to the remote messaging address. In addition, the user is then able to configure the email client server to send emails from the local computer carrying the remote messaging address as the identifying source. This may be desirable in some situations where a user wishes to identify the remote messaging address using a pseudo-name or “vanity name.” However, in some cases, the user identifies a false remote messaging address and configures the client program to place this false remote messaging address on outgoing electronic messages. This is known as “spoofing”.

Thus, it would be advantageous to be able to verify that a user has ownership of the remote messaging address in order to prevent spoofing. This is not necessarily the same as verifying that the user has the ability to login to the remote account, which can simply be done by using the user's signon and password. Rather, in some cases, it may be necessary to prove that the user can send messages from the remote account or forward messages from the remote account.

### BRIEF SUMMARY OF THE INVENTION

The present invention is directed to systems and methods for verifying ownership of remote messaging addresses, including, for example email addresses. While embodiments of the present invention are described in relation to email messaging, it will be appreciated that the features of the present invention may also apply to other messaging contexts such as text messaging or voice messaging.

In summary, when a user identifies a remote messaging address purporting to correspond to a remote account, a verifying message is sent to the remote messaging address. The verifying message includes a marker imbedded therein or otherwise attached to the verifying message. When the verifying message or other response that includes the verifying message is returned, an authentication module identifies the marker, and determines if it is authentic. If it is authentic, then the messaging address for the remote account is considered to be a valid message address. This can be useful to prevent certain third party misconduct such as, for example, spoofing.

Systems of the present invention include a user computer that is in communication with an authentication server. The authentication server includes a messaging program that generates and handles typical aspects of electronic messaging. When a user identifies a remote account and a corresponding remote messaging address, a verification message generator produces a verification message which is sent to the remote account. The remote account includes a messaging server which establishes communication with the messaging server of the authentication server. If the user has identified a false remote messaging address, the verification message will not be successfully delivered to the remote account. Thus, inability to successfully transmit the verification message to the remote account is one indication of a false address.

Generally, a verification message that is returned to the authentication server is an indication that the remote address is valid. However, the authentication server also determines whether the verification message was originally and authentically generated from the authentication server in order to prevent third parties from sending a fabricated or altered verification message to make it appear that the remote messaging address is valid. The present invention provides that the authentication server, when generating a verification message, embeds or attaches a marker to the verification message which is sent to the remote account. The marker is then included in a return verification message which is received or retrieved from the remote account.

In one embodiment, the verification message can be received back at the authentication server by a forwarding rule in which the verification message is automatically forwarded to the authentication server. In another embodiment, the verification message can be retrieved by the authentication server by sending a fetch command and obtaining the original verification message. In both embodiments, the returning verification message includes a copy of the marker that was included in the original verification message.

Once the verification message is received or retrieved from the remote account, the authentication server determines whether the marker contained in the verification message is authentic. In addition, the authentication server may access a database to determine if that particular instance of receiving the marker satisfies one or more use based requirements. If all of these criteria are met, the marker status is valid and the user is allowed access to the remote account.

The marker can be embedded in any portion of the data structure of an electronic message. In one embodiment, the marker is attached as a new header to the content portion of an electronic message. In addition, the marker can be used in combination with other markers (i.e. delivery tickets).

The data structure of the marker may include various features. For example, the marker may include a source identifier, a version indicator, a time stamp, a uniquifier, a checksum, and the domain identifier. The source identifier can be generated from the administrator's email address. The version is typically a one character version indicator that indicates the version of the marker. The time stamp indicates the time that the marker was generated and can be based on the authentication server's geographic location. The uniquifier is typically an unsigned integer that is unique for each marker generated on a particular authentication server in the same second. The checksum is a number that has been computed from the clear text portions of the marker and a private key, or salt, and is used to authenticate the corresponding incoming message. In one embodiment, the checksum is computed using an algorithm and the private key and then sent with the outgoing verification message. The algorithm may be any suitable encryption/signature algorithm, for example, the md5 algorithm. It will appreciated that the marker may contain a different data structure by using other cryptographic, authentication, or digital signature methods.

Generally, a single verification message is sent per request by a user to allow access to a remote account. Correspondingly, a single return verification message should be received or retrieved in response to a single outgoing verification message. A marker is generally based on a single-use and for a limited time basis. When a marker is received by the authentication server, the data structure can be identified as serving the function of the marker and be characterized as single-use and for a certain amount of time. The time can be evaluated by looking at the time stamp in the marker directly. However, additionally, a database may be included to track the number of uses or the amount of time in which a marker is received.

Methods of the present invention thus include, but are not limited to, the user designating a remote account and a corresponding remote address. The remote address's status at this point is pending and the user is not allowed access to the remote account. The user is further not allowed to use the remote address as a source of a message sent from the local account of the user until the remote address and/or remote account is authenticated or verified.

The authentication server generates a verification message. The authentication server attaches a marker into the verification message. The authentication server transmits the verification message to the remote address. The verification message is received or retrieved from the remote server. If the authentication server is unable to retrieve or receive a verification message, the remote address's status is invalid. If the authentication server is able to retrieve the verification message, then the authentication server identifies the existence of a marker in the verification message and determines whether the marker is authentic. In one embodiment, authenticating the marker involves regenerating the checksum. If the marker is not authentic, the remote address's status is invalid.

If the marker is determined as authentic, the authentication server determines if the marker satisfies use based requirements, such as single-usage, or limited time-usage. The particular use of the marker may be recorded in a database accessible by the authentication server. If these use based requirements are not met, the remote address is considered as invalid. However, if the marker is authenticated and satisfies use based requirements, then the remote address's status is valid and communication is established between the user's local account and the user's remote account which may include, among other things, forwarding electronic messages from the remote account to the local account or using the remote address as a source for messages sent or originating from the local account of the user.

Embodiments of the present invention may further be useful to (1) verify the validity of remote messaging address that the user purports to correspond to remote account; (2) to verify that the forwarding function of the authentication server is set up correctly; and (3) identify instances of tampering of electronic messages. One advantage of verifying a remote account is that potential abuses, such as spoofing, can be reduced.

In one example, the verification of the remote messaging address or account is performed in a manner that is transparent to the user. That is, the user is unaware that the remote messaging address is being verified or authenticated.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B illustrate alternative exemplary network environments and systems for implementing features of the present invention, illustrating a message exchange between an authentication server and a remote account;

FIG. 2 illustrates an exemplary data structure for a verification message according to one embodiment of the invention;

FIG. 3 illustrates an exemplary data structure for a database according to one embodiment of the invention; and

FIG. 4 illustrates a flow diagram illustrating one embodiment of implementing the present invention.

### DETAILED DESCRIPTION OF THE PREFERRED EMBODIMENTS

The present invention is directed to systems and methods for verifying ownership of remote messaging addresses, including, for example, email addresses. While embodiments of the invention are described in relation to email messaging, it will be appreciated that the features of the invention may also apply to other messaging contexts such as text messaging and voice messaging.

When a user identifies a remote messaging address purporting to correspond to a remote account, a verifying message is sent to the remote messaging address. The verifying message includes a marker embedded therein or otherwise attached to the verifying message. When the verifying message or other response that includes the verifying message is returned, an authentication module identifies the marker, and determines if it is authentic. If it is authentic, then the messaging address for the remote account is considered to be a valid messaging address. As used herein, a “local account” and a “remote account” are typically associated with different servers, although in some instances, they could be associated with the same server.

Authenticating the messaging address of a remote account is useful because it prevents a user from arbitrarily selecting a messaging address and prevents the user from using an address that the user does not own. For example, a user may designate the remote account as webmaster@example.com. When this happens, the user is able to send outgoing messages from the local account under the false messaging address in order to incite people to respond to their email. When users misrepresent their remote messaging address with the intent to deceive, this type of abuse is known as spoofing. The present invention provides systems and methods for verifying that the remote messaging address actually corresponds to a remote account of the user before allowing the user access to the remote account or to use the remote messaging address in messages being sent from the local client.

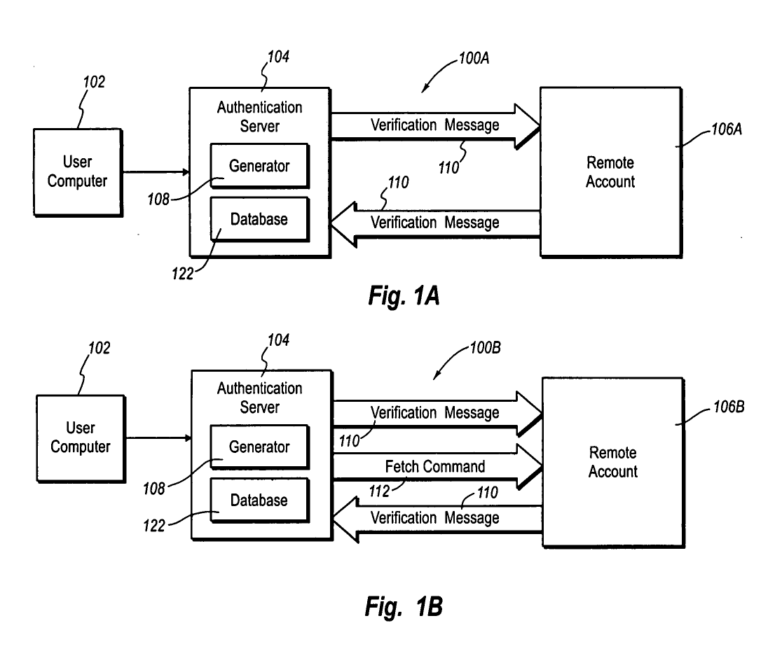

With reference to FIGS. 1A and 1B, exemplary systems 100A and 100B are illustrated, incorporating features of the present invention. As shown in FIG. 1A, a user computer 102 is in communication with an authentication server 104. The authentication server 104 includes a messaging program which generates and handles typical aspects of electronic messaging. When a user identifies a remote account 106A and a corresponding remote messaging address, a verification message generator 108 generates a verification message 110 which is sent to the remote account. The data structure of the verification message 110 will be described below in further detail. The verification message 110 includes a marker which assists the authentication server 104 in determining whether the remote messaging address is valid and belongs to the user. Generally, an administrator has access to the authentication server 104; although in some cases, the user might also have access.

The remote account 106A includes a messaging server which establishes communication with the messaging server of the authentication server 104. If the user has identified a false remote messaging address, the verification message will not be successfully delivered to the remote account. Thus, inability to successfully transmit the verification message to the remote account is one indication of a false address. Generally, a verification message that is returned to the authentication server 104, is an indication that the remote address is valid. However, the authentication server 104 also determines whether the verification message was originally and authentically generated from the authentication server in order to prevent third parties from sending a fabricated or altered verification message to make it appear that the remote messaging address is valid.

Thus, with reference to FIG. 1A, assuming that the verification message 110 is successfully delivered to the remote account 106A, the verification message is returned to the authentication server 104. Receiving the verification message back from the remote account 106A can be accomplished in a couple of different ways. First, as shown in FIG. 1A, verification can take place when the user wishes to forward electronic messages from remote account 106A to the local account 104. In this situation, if a verification message 110 is successfully delivered to the remote account 106A, then the verification message would be automatically forwarded to the authentication server 104 by forwarding rules. Advantageously, this also allows the authentication server 104 to determine that the remote account 106A is properly set up for forwarding functions.

Second, as shown in FIG. 1B, the verification message 110 can be retrieved by authentication server 104. For example, after a verification message 110 is successfully delivered to a remote account 106B, a fetch command 112 can be sent by the authentication server 104 which retrieves the verification message. This second retrieval process may determine whether the remote messaging address is valid when a forwarding rule is not established at the remote account. This second embodiment is useful for protocols or systems allowing access of mail in the remote account, such as POP3 protocol.

Once the verification message is received or retrieved from the remote account 106, the authentication server 104 determines whether the marker contained in the verification message is authentic. In addition, the authentication server 104 may access a database 122 to determine if that particular instance of receiving the marker satisfies one or more use-based requirements. If all of these criteria are met, the marker is statused as valid and the user is allowed access to the remote account.

If the verification message 110 is not returned or is unable to be retrieved, it may indicate, for example: (1) that the user doesn't own the remote account; (2) that the user has not set up the forwarding function correctly; (3) in the embodiment of FIG. 1B, that the user has not specified a correct username and password; (4) evidence of third party interference; and the like.

The systems and methods of the present invention are applicable to any current messaging protocols including, but not limited to, Internet Message Access Protocol (IMAP message protocol) and Post Office Protocol (POP3).

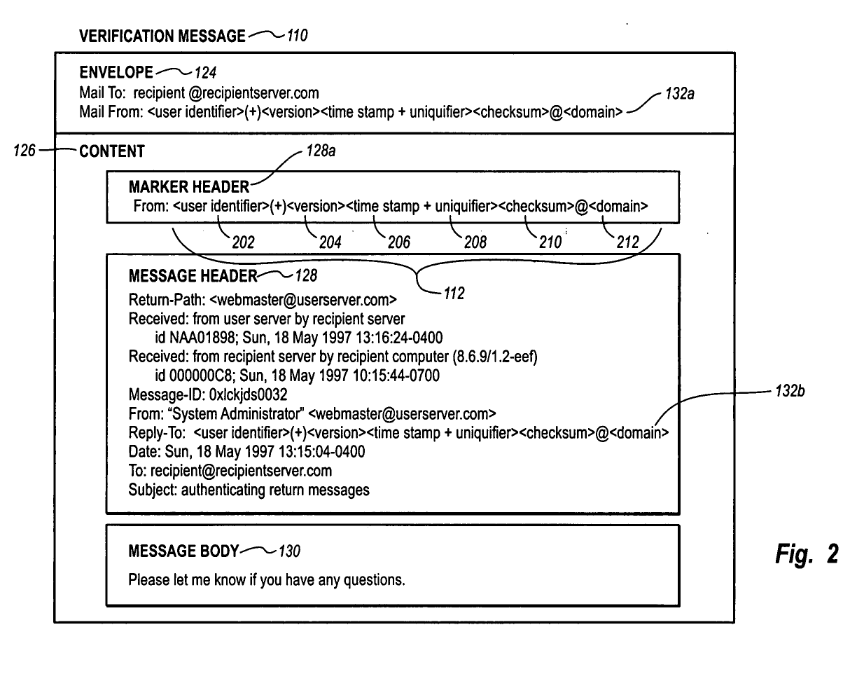

With reference to FIG. 2, an exemplary data structure of a verification message 110 is shown after it has been processed by authentication server 104. As shown in FIG. 2, the verification message 110 includes envelope 124 and content 126. The content includes a header 128 and a body 130.

As shown in FIG. 2, a marker 112 is appended to or embedded in an additional marker header 128a associated with the header 128 of verification message 110. The marker 112 is generated by authentication module 108 of authentication server 104. The marker 112 is generally a unique string which acts as a marker on outgoing messages. The marker is included in verification messages that are received or retrieved from the remote account. Thus, the marker can be identified by the authentication server 104 as relating to an original verification message. The marker 112 may have a variety of features in order to create a unique string. The marker is placed in an appropriate field that will cause it to be included in the forwarded or retrieved message.

The following discussion relates to a specific example of a marker 112 and the various features that are contained in the marker. The following example represents only one way of implementing the markers and any of a variety of other techniques can be used. In this example, the marker 112 includes a source identifier 202, a version indicator 204, a time stamp 206, a uniquifier 208, a checksum 210, and the domain identifier 212. Some or all of the fields may be encrypted.

The source identifier 204 can be derived from the user's email address, e.g., using the user's username. Alternatively, the source identifier 204 is generated from the administrator's email address because the verification message is preferably transparent to the user. Generally, the source identifier 204 has a 32 character maximum.

The version 204 is typically, but not limited to, a one character version indicator that indicates the version of the marker. The time stamp 206 indicates the time that the marker was generated and can be based on the authentication server's 112 geographic location. The uniquifier 208 is typically an unsigned integer that is unique for each marker generated on a particular authentication server 104 in the same second. In one embodiment, the time stamp 206 and uniquifier 208 are generated using an 11 character base 64 encoding of the time stamp and uniquifier.

The checksum 210 is a number that has been computed from the clear text portions of the marker and a private key, or salt, and is used to authenticate the corresponding incoming message. In one embodiment, the checksum is computed using an algorithm and the private key and then sent with the outgoing message. The algorithm may be any suitable encryption/signature algorithm, for example, the md5 algorithm. In another embodiment, the md5 algorithm may be used in combination with a private salt value. When a future incoming message is received with what appears to be a marker 112, the authentication server 104 recomputes the checksum using the same algorithm and secret key and compares it to the checksum that is contained in the marker 112 of the incoming verification message. If they are the same, the incoming message is assumed to be an authentic reply to a previous outgoing message because the entity that generated the incoming message had access to the marker and included it in the incoming verification message.

While markers generally do not ensure that the sender of an incoming message is identical to or has a relationship of trust with the recipient of a previous outgoing message sent by the server 104, the marker nonetheless can be used to confirm that the incoming message has been generated by a sender who has had access to a previous outgoing electronic message sent by the server 104.

After the creation of the checksum and the placement of the marker 112 in the appropriate fields and headers as described above, the message is transmitted by the server system. Authentication server 104 is generally associated with a remote server, which is connected to remote account 106A or 106B. At this point, a copy of the marker 112 is not stored on the authentication server 104, because the server is capable of recognizing valid markers by regenerating the checksum during the verification process.

It will be appreciated that the marker 112 may contain a different data structure by using other cryptographic, authentication or digital signature methods. For example, a segment of random text can be added to the checksum, which would further ensure that the checksum is unique and irreproducible. As discussed above, the marker 112 can be embedded in any part of the verification message as discussed above. For example, a marker header 128a may be configured to include the marker 112.

Generally, a single verification message is sent per request by a user to allow access to a remote account. Correspondingly, a single return verification message should be received or retrieved in response to a single outgoing verification message. A marker is generally based on a single-use and for a limited time basis. Thus, the usage of a particular marker can be inferred from directly examining the marker. The validity of markers that are valid only for a specified period of time can be determined by directly examining the content of the markers without referencing another configuration file or database to obtain this information.

However, to prevent a third party from taking the marker from an outgoing verification message and modifying a message to mimic a return verification message, a marker can be monitored according to the number of times it is used. If used more than once, the server administrator may be notified as this may indicate an attempt to compromise the system. Thus, in the unusual case in which a person who accesses a valid marker included in an outgoing message sent by the user succeeds in misusing the marker, this misuse is limited in time or in the number of electronic messages that can be sent. Moreover, someone who has access to a valid marker and might misuse it would also generally have access to a valid “To:” and “From:” address pair that can be used to successfully send unwanted messages to the user or server (i.e., the party identified by the “From:” address) in an unlimited manner. In other words, the use of a marker does not compromise message security and is useful in permitting certain desirable messages to be successfully delivered as described herein.

In addition, generally a verification message is intended to be received or retrieved immediately after the verification message is sent in order to; allow a user almost immediate access to the remote account. Thus, if a verification message takes an unusual amount of time to be received or retrieved, it is an indication that the remote account is invalid. In addition, if a marker is received in more than the predetermined amount of time, it may indicate that a third party has tampered with the marker.

One example of the specific disablement of a marker could occur when it has been determined that a marker having a duration of one day has been compromised. In response to this determination, an administrator can specifically disable the marker to avoid a security hole. One benefit of time-based markers is that database entries for incoming markers do not need to be maintained.

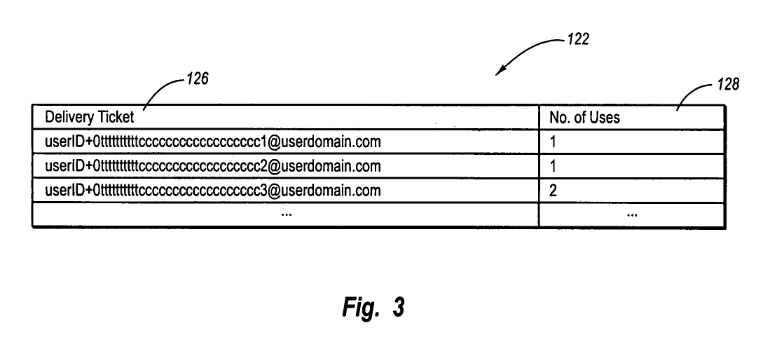

As shown in FIG. 3, a database 122 tracks the number of usages of a particular marker. The database 122 is populated or updated each time a marker is received in an incoming electronic message. The database can also be updated when the administrator determines that a particular marker has been misused or compromised. Database 122 contains a field 126 for identifying individual markers and a field 128 that has a counter tracking the number of times the particular marker has been used. In addition, the database 122 can be modified to include a time field which compares the time stamp of the outgoing marker to the time that the incoming marker is received to determine if the marker is received beyond a predetermined time period. Any of a variety of data structures containing the necessary information can be used, and any such data structure is referred to herein as a marker “database.”

As shown in FIG. 2, the marker 112 may be combined with one or more markers 132a, 132b, each being intended to be used for various types of possible return messages that can be received by the authentication server 104. One example of markers 132a, 132b are for use as delivery tickets. In general, a delivery ticket identifies an outgoing message as being generated by the user. Thus, when an incoming message (e.g., a bounce or forwarded message) is returned to the authentication server containing the delivery ticket, it is allowed to bypass challenge/response mechanisms or other filtering mechanisms that would normally prevent the incoming message from being sent to the user's inbox. Delivery tickets are described in more detail in co-pending U.S. patent application Ser. No. 10/747,557, filed Dec. 29, 2003, and entitled “Systems and Methods for Authorizing Delivery of Incoming Messages,” which application is incorporated herein by reference in its entirety. For example, a first delivery ticket 132a may be included in the envelope of the outgoing message, either in the “Envelope From:” field or in the “Mail From:” field to permit bounce messages to be recognized as valid. A second delivery ticket 132b can also be placed in the “Reply To:” header or in the “References” header of the outgoing message to permit replies to outgoing messages to be recognized as being valid. In yet another embodiment, a marker 112 may serve both its present function described herein and the function of a delivery ticket.

In the embodiment where marker 112 is combined with one or more-delivery tickets 132 or partially serves as a delivery ticket, a configuration file would be helpful in defining the proper usage for each marker and/or delivery ticket. A configuration file is described in more detail in the immediately-referenced patent application. Defining markers in this manner eliminates the need to separately define this information in the configuration file or another database for each individual marker.

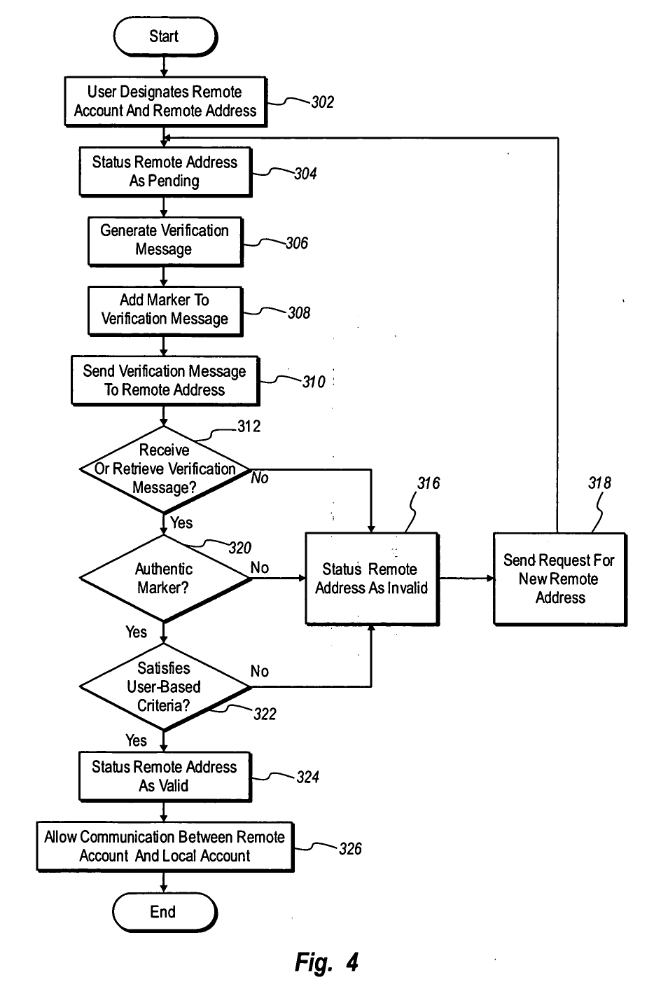

FIG. 4 illustrates an exemplary flow diagram of one preferred method for implementing features of the present invention. At 302, a user designates a remote account and a corresponding remote address. At 304, the remote address is statused as pending. At 306, the authentication server generates a verification message. At 308, the authentication server attaches or embeds a marker into the verification message. 306 and 308 could be combined to form a single step.

At 310, the authentication server transmits the verification message to the remote address. At 312, the authentication determines whether a verification message is received or retrieved from the remote server. At 316, if the authentication server is unable to retrieve a verification message at the remote address, the remote address is statused as invalid and the user is unable to associate his/her local account with the remote account or is unable to access the remote account. At 318, the user is given another opportunity to provide a remote address 304 through 312 are then repeated.

If the authentication server is able to retrieve the verification message, then the process proceeds to 320 where the authentication server identifies the existence of a marker in the verification message, and, determines whether the marker is authentic. The initial step for authenticating the marker involves regenerating the checksum as described above. If the marker is not authentic, then at 316, the remote address is statused as invalid. At 318, the user can designate another remote address, which would cause 304 through 312 to be repeated. For repeat abusers who try consistently to use an invalid address, the system may be configured to disallow the user to have privileges to access the remote account after a specified number of tries.

At 322, if the marker is determined as authentic, that is, if the checksum is successfully regenerated, the authentication server optionally determines if the marker satisfies certain use-based requirements, as discussed above. The particular use of the marker is recorded in the database. In addition, the time stamp of the marker is used to determine whether the marker has been received within a specified time. If the time has expired, or if the particular use exceeds the allowed number of uses, the marker is declared invalid and the user is not allowed access to the remote account. The process then goes to 316.

At 324, if the marker is authentic and/or satisfies user or use based criteria, then the remote address is statused as valid and, at 326, communication may be established between the user's local account and the user's remote account which may include, among other things, forwarding electronic messages from the remote account to the local account. An additional step may also be added wherein the authentication server sends an electronic message to the user to inform the user that the remote address has been successfully or unsuccessfully verified.

In summary, the present invention may be useful to (1) verify the validity of a remote messaging address that the user purports to correspond with a remote account; (2) to verify that the forwarding function of the authentication server is set up correctly; and (3) identify instances of tampering of electronic messages. One advantage of verifying a remote account is that potential abuses, such as spoofing, can be reduced.

The above method describes conditions that combine use-based rules and time-based rules. That is, a marker can be valid for a single use and for a certain amount of time, meaning that if either condition fails, the marker is invalid. In this case, the database 122 does not need to store the marker information for an extended period of time.

In one embodiment, the verification process of the present invention is performed in a manner that is transparent to the user. That is, the user is unaware that the remote messaging address is being verified. If the remote messaging address is authentic, the user is allowed immediate access. However, if the remote messaging address is identified as false by the above verification process, an electronic message may be sent to the user at the local client that the remote messaging address is invalid and may allow the user to identify a different remote messaging address.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In an authentication server included in an electronic messaging system, wherein a user desires to configure the electronic messaging system to associate a remote account with a local account, a method of verifying that a remote messaging address provided by the user corresponds to the remote account, the method comprising:
generating an outgoing verification message having a marker embedded therein;
sending the outgoing verification message to a remote messaging address;
receiving the verification message forwarded from the remote account;
analyzing the forwarded verification message to identify whether the forwarded verification message contains the marker; and
if the forwarded verification message contains the marker, authenticating the marker to determine whether the marker is the same as that embedded in the outgoing verification message

2. The method as recited in claim 1, wherein authenticating the marker comprises regenerating a checksum related to the forwarded verification message to determine if the regenerated checksum is the same as the checksum related to the outgoing verification message.

3. The method as recited in claim 1, further comprising validating the remote address to allow a user access to the remote account if the marker is authenticated.

4. The method as recited in claim 1, further comprising referencing a database to determine the use of the marker.

5. The method as recited in claim 4, wherein the use of the marker is defined as at least one of single-based, multiple-based, and time-based usage.

6. The method as recited in claim 5, further comprising validating the remote address to allow a user access to the remote account if the marker is authenticated and if the marker complies with the defined use.

7. In an authentication server included in an electronic messaging system, wherein a user desires to configure the electronic messaging system to associate a remote account with a local account, a method of verifying that a remote messaging address provided by the user corresponds to the remote account, the method comprising:
generating an outgoing verification message having a marker embedded therein;
sending the outgoing verification message to a remote messaging address;
sending a fetch command to the remote account to retrieve the verification message;
analyzing the retrieved verification message to identify whether the retrieved verification message contains the marker; and
if the retrieved verification message contains the marker, authenticating the marker to determine whether the marker is the same as that embedded in the outgoing verification message.

8. The method as recited in claim 7, wherein authenticating the marker comprises regenerating a checksum related to the retrieved verification message to determine if the regenerated checksum is the same as the checksum related to the outgoing verification message.

9. The method as recited in claim 7, further comprising validating the remote address to allow a user access to the remote account if the marker is authenticated.

10. The method as recited in claim 7, further comprising referencing a database to determine the use of the marker.

11. The method as recited in claim 10, wherein the use of the marker is defined as at least one of single-based, multiple-based, and time-based usage.

12. The method as recited in claim 11, further comprising validating the remote address to allow a user access to the remote account if the marker is authenticated and if the marker complies with the defined use.

13. In an authentication server included in an electronic messaging system, wherein a user desires to configure the electronic messaging system to access a remote account, a method of verifying a remote address purporting to correspond to the remote account, the method comprising:
receiving server information about a remote account;
receiving a remote messaging address that is associated with the remote account;
generating an outgoing verification message having a marker embedded therein;
sending the outgoing verification message to the remote messaging address;
determining whether the marker is included in a return verification message received from the remote account; and
authenticating the marker to verify the remote messaging address.

14. The method as recited in claim 13, further comprising invalidating the remote messaging address if a return verification message is not received.

15. The method as recited in claim 13, wherein the return verification message is received per forwarding rules at the remote account.

16. The method as recited in claim 13, wherein the return verification message is received per a fetch command sent to the remote account.

17. The method as recited in claim 13, further comprising analyzing the return verification message to identify whether the return verification message contains the marker.

18. The method as recited in claim 17, further comprising authenticating the marker to determine whether the marker is the same as that embedded in the outgoing verification message.

19. The method as recited in claim 18, wherein authenticating the marker comprises regenerating a checksum for the incoming verification message and determining whether the regenerated checksum is the same as a checksum for the outgoing verification message.

20. The method as recited in claim 13, wherein generating an outgoing verification message having a marker embedded therein comprises generating a header for the marker, the header being located in the content portion of the outgoing verification message.

21. In an authentication server included in an electronic messaging system, wherein a user desires to configure the electronic messaging system to receive electronic messages forwarded from a remote account, a method of verifying a remote messaging address for a remote account that is configured to forward electronic messages, the method comprising:
receiving server information about a remote account;
receiving a remote messaging address that is associated with the remote account;
sending a verification message having a marker embedded therein to the remote messaging address;
determining whether a forwarded verification message is received from the remote account; and
statusing the remote messaging address as invalid if a forwarded message is not received from the remote account.

22. The method as recited in claim 21, further comprising informing the user that the forwarding protocol of the remote account is not properly configured if a forwarded message is not received from the remote account.

23. The method as recited in claim 21, further comprising statusing the forwarding protocol of the remote account as being properly configured if a forwarded message is received from the remote account.

24. The method as recited in claim 21, further comprising determining whether the forwarded verification message received from the remote account contains the marker embedded therein.

25. The method as recited in claim 24, further comprising authenticating the marker, wherein authenticating the marker comprises regenerating a checksum for the forwarded verification message and determining whether the regenerated checksum is the same as a checksum contained in the marker.
